(19) United States
(12) Patent Application Publication
(10) Pub. No.: US 2003/0026230 A1
(43) Pub. Date: Feb. 6, 2003

(54) Proxy duplicate address detection for dynamic address allocation

(76) Inventors: Juan-Antonio Ibanez, Aachen (DE); Vidar Oliver Lilleheim, Bjorbekk (NO); Hesham Soliman, Victoria (AU); Bernard Volz, Ashland, MA (US)

Correspondence Address: JENKENS & GILCHRIST, P.C., 3200 Fountain Place, 1445 Ross Avenue, Dallas, TX, 75202-2799, US

(21) Appl. No.: 09/934,180

(22) Filed: Aug. 20, 2001

Related U.S. Application Data
(60) Provisional application No. 60/309,958, filed on Aug. 2, 2001.

(51) Int. Cl. H04Q 7/24

(52) U.S. Cl. 370/338; 370/475

(57) ABSTRACT

A system, method, and apparatus for duplicate address detection in a communication network includes a plurality of communication nodes and a proxy node. A particular one of the communication nodes generates a tentative interface address and transmits a solicitation message including the tentative interface address to the proxy node. After receiving the solicitation message, the proxy node determines from the solicitation message whether the tentative interface address is allocated to another of the communication nodes. If the proxy node determines that the tentative interface address has been allocated to another communication node, the proxy node sends a response message to the particular communication node.

### CROSS-REFERENCE TO RELATED APPLICATIONS

This patent application is related to and claims priority from U.S. Patent Application No. 60/309,958, filed Aug. 2, 2001.

### BACKGROUND OF THE INVENTION

1. Technical Field of the Invention

This invention relates to the assignment of dynamic addresses, and more particularly to a system and method for detecting duplicate addresses.

2. Description of Related art

Internet Protocol version 6 (IPv6) defines a mechanism that allows a host to automatically generate an IPv6 address that the host can use to communicate with other hosts connected to the same link, without involvement of a central entity responsible for allocating addresses, and without requiring manual configuration of the address in the host. Such an IPv6 address is called a “link-local address”. The link-local address is constructed by appending an identifier of the interface the host is going to use, called the “interface identifier”, to a link-local prefix. The interface identifier can be randomly or pseudo-randomly generated by the host, or selected by the host from a pre-programmed list of possible interface identifiers. A well-know link-local prefix is defined in Internet Engineering Task Force (IETF) document RFC 2373, published July 1998, and is equal to a value of FE80::0, where the notation of “::” indicates multiple groups of 16-bits of zeros.

Once a host has generated its link-local address it must verify that the link-local address is unique on the link it is connected to, i.e., it must determine whether or not another host connected to the same link is already using the same link-local address before starting to use it. Such a procedure is necessary because the interface identifier is chosen by the host itself, and as such, it cannot be guaranteed that it will be unique among all hosts connected to the link. For this purpose, the host carries out a duplicate address detection procedure after generating a link-local address.

An example of such a duplicate address detection procedure is described in IETF document RFC 2462, published December 1998. In accordance with the duplicate address detection procedure, a host determines or selects a tentative link-local address to use for communication on the network. The host then sends a multicast message called a “Neighbor Solicitation” to all nodes connected to the same link, with the tentative link-local address specified as a target address. If a node connected to the same link is using the tentative link-local address, that node replies by sending a multicast message called a “Neighbor Advertisement” to all the nodes connected to the link, thus announcing the link-local address that node is using to the other nodes on the link. If the host that initiated the duplicate address detection procedure receives a Neighbor Advertisement message advertising the link-local address that the host is trying to acquire, the host will then deduce that its tentative link-local address is already in use. The host will then choose a different interface identifier, if possible, and restart the procedure. Otherwise, the stateless address autoconfiguration procedure will fail and the error will be reported to the user. If the host does not receive any Neighbor Advertisement message in response to the Neighbor Solicitation message, the host can assume that the tentative link-local address is unique, and the host can start using the selected link-local address to communicate with other nodes connected to the same link.

Once the link-local address has been successfully configured, the host can build additional IPv6 addresses with a broader scope, namely site-local and/or global IPv6 addresses, by discovering network prefixes associated with routers that are connected to the link and by appending the interface identifier used to create the link-local address to the network prefixes.

The process by which an IPv6-capable host produces its link-local address, verifies its uniqueness by means of the duplicate address detection procedure, and subsequently builds its site-local and/or global addresses is called “IPv6 stateless address autoconfiguration” and is described in RFC 2462.

General packet radio service (GPRS) is a standard that allows for packet data in GSM and other wireless communication systems. By adding GPRS functionality to the mobile network, operators can give their subscribers resource-efficient access to external Internet Protocol-based (IP) networks. It is possible to implement at least some aspects of IPv6 protocols in GPRS systems. However, the use of normal duplicate address detection procedures are avoided in current GPRS systems. The reason for avoiding duplicate address detection in current GPRS systems is that the IPv6 stateless address autoconfiguration mechanism relies on the multicasting of Neighbor Solicitation messages from the terminal to be autoconfigured to all other terminals connected to the same link. If duplicate address detection, such as that described in IPv6, is performed in a conventional manner in a GPRS system, the mobile station will first send a Neighbor Solicitation message to a gateway GPRS support node (GGSN). The GGSN will then relay the Neighbor Solicitation message over the radio interface to all mobile stations connected to the same Access Point Name (APN) in the GGSN. This procedure would involve the sending of messages to potentially several thousands of mobile stations over the radio interface, consuming an expensive and scarce resource.

Therefore a system and method is needed for duplicate address detection in a packet radio system that does not require the multicasting of messages to a large number of Mobile Stations.

### SUMMARY OF THE INVENTION

The present invention comprises a system, method, and apparatus for duplicate address detection in a communication network. In one aspect of the present invention, a system for duplicate address detection in a communication network includes a plurality of communication nodes and a proxy node. A particular one of the communication nodes generates a tentative interface address and transmits a solicitation message that includes the tentative interface address to the proxy node. After receiving the solicitation message, the proxy node determines from the solicitation message whether the tentative interface address is allocated to another of the communication nodes. If the proxy node determines that the tentative interface address has been allocated to another communication node, the proxy node sends a response message to the particular communication node.

In another aspect of the present invention, a method for duplicate address detection in a communication network involves a generation of a first tentative interface address at a first one of a plurality of communication nodes. A first solicitation message including the first tentative interface address is transmitted from the first communication node and received at a proxy node. The proxy node determines that the first tentative interface address is available for use by the first communication node and the first tentative interface address is allocated as a first allocated interface address associated with the first communication node. A second tentative interface identifier is generated by a second one of the plurality of communication nodes. A second solicitation message including the second tentative interface address is transmitted from the second communication node to the proxy node. The proxy node then determines whether the second tentative interface address corresponds to the first allocated interface address. If the proxy node determines that the second tentative interface address corresponds to the first allocated interface address, a first response message is generated and transmitted to the second communication node.

In still another aspect of the present invention, a proxy node for duplicate address detection in a communication network is described. The proxy node includes an input interface for receiving a solicitation message that includes a tentative interface address associated with a particular one a plurality of communication nodes. The proxy node also includes a memory for storing information relating to interface addresses that are currently allocated to the communication nodes. The proxy node includes a processor which is operable to determine from the received solicitation message, and using the stored information, whether the tentative interface address is allocated to another of the communication nodes. The processor is further operable to generate a response message if it is determined that the tentative interface address is allocated to another of the communication nodes. The proxy node also includes an output interface for transmitting the response message to the particular communication node.

In still another aspect of the present invention, a method for duplicate address detection in a communication network includes receiving, by a proxy node, a solicitation message including a tentative interface address, the tentative interface address being associated with a particular one of a plurality of communication nodes. The method further includes determining, from the solicitation message, whether the tentative interface address is allocated to another of the plurality of communication nodes. The method further includes sending a response message to the particular communication node if as a result of the determining step, the proxy node determines that the tentative interface address is allocated to another of the plurality of communication nodes.

In still another embodiment of the present invention, a computer program stored on a computer-readable medium, loadable into the internal memory of a digital processing unit is described. The computer program includes software code portions adapted to execute the step of receiving, by a proxy node, a solicitation message including a tentative interface address, the tentative interface address being associated with a particular one of a plurality of communication nodes. The software code portions are further adapted to execute the step of determining, from the solicitation message, whether the tentative interface address is allocated to another of the plurality of communication nodes. In addition, the software instructions are adapted to execute the step of sending a response message to the particular communication node if the proxy node determines that the tentative interface address is allocated to another of the plurality of communication nodes.

### BRIEF DESCRIPTION OF THE DRAWINGS

For a more complete understanding of the present invention, reference is made to the following detailed description taken in conjunction with the accompanying drawings wherein:

FIG. 1 is a block diagram of an illustrative mobile telecommunication network that includes a general packet radio service (GPRS) system;

FIG. 2 is a signaling and message flow diagram of an IPv6 stateless address autoconfiguration procedure in accordance with current GPRS standards;

FIG. 3 is a block diagram of a gateway GPRS support node (GGSN) that can be used for implementing the present invention;

FIG. 4 is a signaling and flow diagram of an IPv6 stateless address autoconfiguration procedure in accordance with one embodiment of the present invention;

FIG. 5 is a flow diagram illustrating the processing of a Neighbor Solicitation message in accordance with one embodiment of the present invention; and

FIG. 6 is a flow diagram illustrating the processing of a Neighbor Solicitation message in accordance with another embodiment of the present invention.

### DETAILED DESCRIPTION OF THE INVENTION

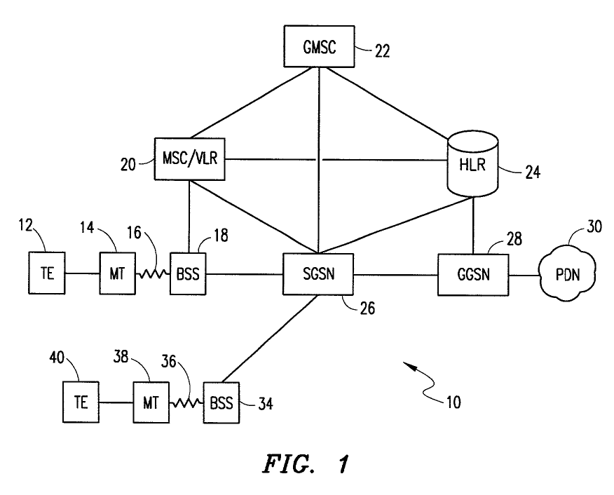

Reference is now made to the Drawings wherein like reference characters denote like or similar parts throughout the various Figures. Referring to FIG. 1, there is shown a block diagram of an illustrative mobile telecommunication network that includes a general packet radio service (GPRS) system 10. First terminal equipment (TE) 12, which supports packet data protocol communication, is in communication with a mobile terminal (MT) 14. The mobile terminal 14 communicates over a wireless communication link 16 with a base station subsystem (BSS) 18. The BSS 18 is in communication with a mobile switching center/visitor location register (MSC/VLR) 20 that supports wireless voice communications and a serving GPRS support node (SGSN) 26 that supports wireless packet data communications. The MSC/VLR 20 is further in communication with a gateway mobile switching center (GMSC) 22 and a home location register (HLR) 24 as will be understood by those of ordinary skill in the art.

The SGSN 26 is in communication with at least a gateway GPRS support node (GGSN) 28 for purposes of routing data to and receiving data from external networks. In some cases the SGSN 26 is also connected to the MSC/VLR 20, the GMSC 22, and the HLR 24 for purposes of coordinating voice and data communications and for sharing access to subscriber information. The GGSN 28 serves to interconnect the GPRS system 10 with a packet data network (PDN) 30. In the GPRS system of FIG. 1, the SGSN 26 is also in communication with a second BSS 34. The second BSS 34 communicates over a wireless communication link 36 with a second mobile terminal (MT) 38. The second mobile terminal (MT) 38 communicates with second terminal equipment (TE) 40, which supports packet data protocol communication. Although each BSS 18 & 34 is shown as being in wireless communication with only one mobile terminal 14 & 38, it will be understood by those of ordinary skill in the art that each BSS 18 is capable of communicating with a large number of mobile terminals 14.

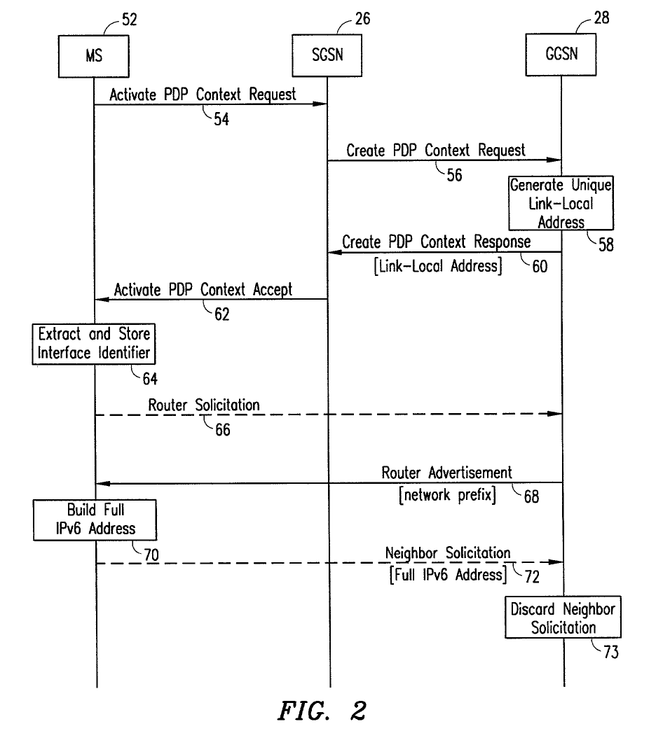

Referring now to FIG. 2, there is shown a signaling and message flow diagram of an IPv6 stateless address autoconfiguration procedure in accordance with GPRS release 99 standard as described in 3GPP TS 23.060, version 3.8.0, issued in June 2001. Current General Packet Radio Service (GPRS) standards, starting from release 99, support a modified IPv6 stateless address autoconfiguration procedure in which the GGSN 28 generates and assigns link-local addresses for MSs 52 connected to the network. In particular, the MS 52 requests activation of a Packet Data Protocol (PDP) context by sending an Activate PDP Context Request message 54 to the SGSN 26 with the PDP type field set to IPv6, the PDP address left empty, and the Access Point Name (APN) field set to a value that corresponds to an APN that the network operator has configured to support the IPv6 stateless autoconfiguration process.

The SGSN 26 validates the request received from the MS 52 based on subscription information associated with the MS 52 and other local information and sends a Create PDP Context Request message 56 to the GGSN 28. The GGSN 28 validates the request based on local information, and because the PDP type requested is IPv6, the GGSN generates, in step 58, a link-local address that is unique on the requested APN. The link-local address consists of the well-known IPv6 link-local prefix, e.g., (FE80::0), followed by zero or more 0 bits and an interface identifier generated by the GGSN 28 so that the link-local address is unique for the requested APN. The GGSN 28 returns the link-local address in the PDP address field of a Create PDP Context Response message 60 sent to the SGSN 26.

The SGSN 26 relays the response to the MS 52 in an Activate PDP Context Accept message 62. Upon reception of this message, in step 64, the MS 52 extracts the interface identifier from the link-local address the MS 52 has received and stores it locally. In an application in which the MS 52 is physically split into a Mobile Terminal (MT) 14 and a Terminal Equipment (TE) 12, the MT 14, which is the entity actually receiving the Activate PDP Context Accept message 62, transfers the interface identifier to the TE 12, which then stores it locally.

In some cases, MS 52 sends a Router Solicitation message 66 after a predetermined time to activate the sending of a Router Advertisement message 68. However, under normal conditions, the GGSN 28 automatically sends a Router Advertisement message 68 containing the network prefix associated with the requested APN. In GPRS release 99 only one network prefix is advertised by the GGSN. In step 70, the MS 52, upon reception of the Router Advertisement message 68, builds its full IPv6 address by concatenating the network prefix received in this message and the interface identifier that it stored previously.

It should be understood that although integrated terminals can be designed to not perform any duplicate address detection, in the case where the MS 52 is physically split into an MT 14 and a TE 12, it is possible that the TE 12, which can be, for instance, a portable computer with a standard IPv6 protocol stack, might carry out the duplicate address detection procedure even after the GGSN 28 ensures uniqueness. Accordingly, the MS 52 may send a Neighbor Solicitation message 72 as part of the duplicate address detection procedure to ascertain whether the newly constructed IPv6 address, and possibly also the link-local address, is not already being used by other mobile stations or terminals. However, because the GGSN 28 ensures the uniqueness of the addresses it allocates, duplicate address detection is unnecessary. Therefore, at step 73, the GGSN 28 discards any Neighbor Solicitation message received from the MS 52 when used for duplicate address detection.

An important reason for seeking to avoid duplicate address detection in GPRS is that the typical IPv6 stateless address autoconfiguration mechanism relies on the multicasting of Neighbor Solicitation messages from a terminal to be autoconfigured to all other terminals connected to the same link. In GPRS, a link is materialized by a connection from an MS 52 to an APN within the GGSN 28. Therefore, duplicate address detection within GPRS would imply the multicasting of Neighbor Solicitation messages to all mobile stations connected to the same APN. Not only would this involve the sending of messages to potentially several thousands of mobile stations, but more importantly, all of these messages would have to be transferred over the radio interface, which is an expensive and scarce resource.

As a consequence, the procedure currently supported in GPRS release 99, as described above, is mainly intended to make the duplicate address detection procedure superfluous. In the aforementioned procedure, if it can truly be guaranteed that the address used by the MS 52 is created by the GGSN 28 and is unique for a given APN, then Neighbor Solicitation messages received from the MS 52 as part of the duplicate address detection procedure can be ignored by the GGSN 28. The GGSN 28 can simply discard them rather than relaying them to all other mobile stations. This assumption is made in the procedure described by GPRS release 99, in which these messages are actually discarded by the GGSN 28.

However, there are cases where the GGSN 28 that assigns the interface identifier, at the time of activation of a PDP context, is not necessarily capable of ensuring uniqueness of the address actually used by the MS at any point in time. In general, it cannot be assumed that it is possible in all cases to force an MS to use an interface identifier provided by the GGSN. For example, when the terminal is composed of a TE 12 (e.g., a laptop) connected to an MT 14 and the TE 12 uses a standard IPv6 protocol stack, the TE 12 might not recognize that the GGSN 28, rather than the TE 12 itself, is responsible for allocating interface identifiers.

If the MS can, on its own, change its interface identifier during the lifetime of a PDP context without involving the GGSN, the addresses generated from this interface identifier may be duplicated, i.e. already used by another MS connected to the same APN. For instance, privacy extensions for stateless address autoconfiguration in IPv6, such as those described in IETF document RFC 3041, published January 2001, allow a host to regularly change its interface identifier. Such mechanisms when implemented, for instance in a laptop (TE) connected to a GPRS terminal (MT), would result in the TE periodically generating a new, pseudo-random interface identifier, and therefore using the new interface identifier instead of the one produced by the GGSN. As a consequence, the uniqueness of the addresses created by the MS is no longer assured.

In particular, after changing to the new interface identifier, an MS 52 implementing the privacy extensions described by RFC 3041 will build a new site-local or global address, and send Neighbor Solicitation messages to verify whether or not the new address is unique. However, in the procedure described in GPRS release 99, the GGSN 28 will discard the Neighbor Solicitation messages received from the MS 52. Thus, there will be no duplicate address detection for the new address. Even if the new address is already being used, the MS 52 will not receive any Neighbor Advertisement message in return announcing that its tentative address is already in use. As a result, the MS 52 will consider its new address as unique and will start using the new address. As the GGSN 28 will not know that the MS 52 has acquired a new address, the GGSN 28 will discard any packets that are received from the external network having the new address of the MS 52 as a destination IP address, or, if the tentative address is already in use by another MS, the GGSN 28 can incorrectly route packets destined for that address. If the GGSN 28 performs anti-spoofing filtering on packets that the GGSN 28 receives from the mobile stations, for example, checking if the source address corresponds to the source address assigned to the PDP context on which the packet has been received, the GGSN 28 will discard all packets received from the MS having the new address as source address.

It should further be understood that other situations may arise in the future, as new mechanisms for IPv6-enabled hosts are defined, in which support for a duplicate address detection procedure in the GPRS environment becomes necessary.

In accordance with an embodiment of the present invention, a Proxy Duplicate Address Detection (Proxy DAD) function is introduced in the GGSN 28. The Proxy DAD function operates to reply to the Neighbor Solicitation messages sent by a mobile station (MS) with a Neighbor Advertisement message on behalf of the other MSs connected to the same APN. The GGSN 28 searches for a match of the tentative address received in the Neighbor Solicitation message in a list of all IP addresses currently in use by other MSs connected to the same APN. The list of IP addresses in use is maintained by the GGSN 28 as part of the standard PDP context handling procedures. If a match for the tentative addresses is found, the GGSN sends a Neighbor Advertisement message to the MS 52 indicating that the tentative address is in use. In an alternative embodiment, the proxy function can be performed by a separate node from the GGSN 28. In yet another alternative, the proxy function is located in a separate node but the list of all IP addresses currently in use is stored in a memory located in the GGSN 28. It should also be noted that, in any of these embodiments, it is not necessary to store complete IP addresses in the list. Instead, it is possible to store only a characteristic part of each complete IP address, such as the link identifier.

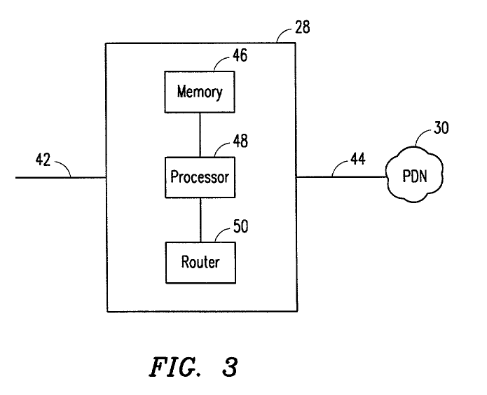

Referring now to FIG. 3, there is shown a block diagram of a gateway GPRS support node (GGSN) 28 that can be used for implementing the present invention. The GGSN 28 includes a first input/output interface 42 in communication with SGSN 26 in the GPRS network 10 and a second input/output interface 44 in communication with an external packet data network (PDN) 30. The GGSN 28 includes a processor 48 for executing software instructions which operate to perform the functions of the GGSN 28. A memory 46 associated with processor 48 stores the software instructions as well as other data related to the GGSN 28. In particular, in accordance with the present invention, the GGSN 28 acts as a proxy for performing duplicate address detection by determining whether tentative interface addresses that are selected by mobile terminals 38 or terminal equipment 40 within the GPRS network 10 conflict with addresses that have already been allocated to other mobile stations within the GPRS network 10. To perform this function, the memory 46 stores a list of allocated interface addresses and the processor 48 uses the stored list to determine whether each selected tentative interface address has already been assigned to another mobile station. The GGSN 28 also includes a router 50 associated with the processor 48 that allows the routing of packet data between the GPRS network 10 and the packet data network 30.

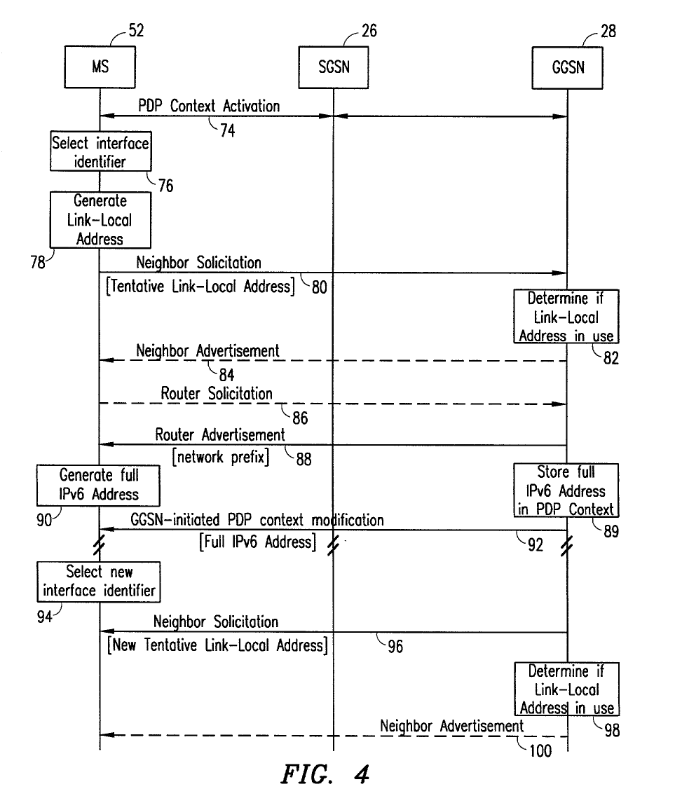

Referring now to FIG. 4, there is shown a signaling and message flow diagram of an IPv6 stateless address autoconfiguration procedure in accordance with one embodiment of the present invention. The MS 52 initiates a PDP context by sending a PDP context activation message 74 requesting the activation of a PDP context of type IPv6 towards an APN within the GGSN 28 that the operator has configured to support the IPv6 stateless autoconfiguration process. The PDP context is created with an empty PDP address. However, the GGSN 28 does not assign and return any IP address during the PDP context activation procedure.

Once the PDP context has been created, the MS 52 selects an interface identifier if one is available in step 76, or alternatively generates one. In step 78, the MS 52 then creates its tentative link-local address by concatenating the well-known link-local prefix (FE80::0) and the selected interface identifier. Then, the MS 52 sends a Neighbor Solicitation message 80 as part of the duplicate address detection procedure with the target address set to its tentative link-local address. After receiving the Neighbor Solicitation message 80, the GGSN 28 determines whether or not another MS is already using the same link-local address in step 82. If the GGSN 28 determines that another MS is already using the same link-local address, the GGSN 28 sends a Neighbor Advertisement message 84 to the MS 52 indicating that the tentative address is in use. Otherwise, if the MS 52 does not receive a Neighbor Advertisement message 84, the MS 52 assumes that the link-local address is unique. In an alternative embodiment, if the MS 52 does not receive a Neighbor Advertisement message 84 after repeating the sending of the Neighbor Solicitation message 80 a predetermined number of times, the MS 52 assumes that the link-local address is unique.

Once the MS 52 has determined that its link-local address is unique, the MS 52 may send a Router Solicitation message 86 after a predetermined time to activate the sending of a Router Advertisement message 88. Preferably, however, the GGSN 28, automatically and periodically sends a Router Advertisement message 88 containing the network prefix associated with the requested APN. In GPRS release 99 only one network prefix is advertised by the GGSN 28, although it may be possible in the future to have multiple network prefixes associated with the same APN in the GGSN 28. In step 90, the MS 52, upon reception of the Router Advertisement 88, builds its full (i.e. site-local or global) IPv6 address by concatenating the network prefix received in this message and the interface identifier composing its link-local address. At this point, the MS 52 can send Neighbor Solicitation messages as part of the duplicate address detection procedure to ascertain that the newly constructed IPv6 is not already being used by another MS; however, because the full IPv6 address is constructed from the interface identifier for which uniqueness has already been verified, the duplicate address detection procedure is unnecessary in this case.

After sending the Router Advertisement message 88 for the first time on the new PDP context, the GGSN 28 stores, at step 89, the full IPv6 address in the PDP context associated with the MS 52, and initiates a PDP context modification procedure 92 to update the IP address stored in the SGSN 26 for the PDP context with the full IPv6 address of the MS 52. The PDP context modification procedure is necessary for the implementation of the autoconfiguration procedure in GPRS release 99, however it may not be necessary in future GPRS releases. The link-local address does not need to be stored in the PDP context since it will generally not be used as a source or destination address in packets sent to or received from the external network, i.e., a link-local address is not routed by the GGSN 28.

If the MS 52 implements the privacy extensions for stateless address autoconfiguration in IPv6 according to RFC 3041, in step 94, the MS 52 may change its interface identifier and build a new site-local or global address after a predefined period of time. The MS 52 sends a Neighbor Solicitation message 96 with the target address set to its new tentative address to verify whether or not another MS is already using this address. After receiving the Neighbor Solicitation message 96, in step 98, the GGSN 28 determines whether or not another MS is already using the same address. If the GGSN 28 determines that another MS is already using the new tentative address, the GSSN 28 sends a Neighbor Advertisement message 100 to the MS 52.

If the MS 52 receives the Neighbor Advertisement message 100 announcing that its tentative address is already in use, the MS 52 will preferably generate a different interface identifier and send a new Neighbor Solicitation message. If a unique address is not found after a predefined number of retries, the procedure will fail and the error will be reported to the user. If no Neighbor Advertisement is received by the MS 52 after sending the Neighbor Solicitation message 96 one or more times with the same tentative address, the MS 52 will consider the IPv6 address contained in the most recent Neighbor Solicitation message 96 as unique and will start using the new address for packet data communication.

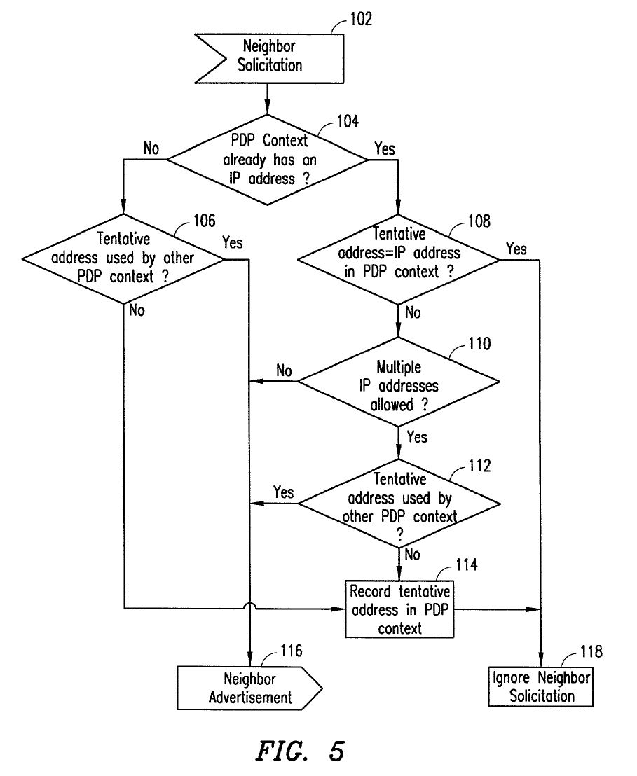

Referring now to FIG. 5, a flow diagram is shown illustrating the processing of a Neighbor Solicitation message in accordance with one embodiment of the present invention. In accordance with this embodiment of the present invention, more than one IP address is allowed per PDP context. Such a configuration might be necessary, for instance, if the inherent limitation to one IP address per PDP context, as described in GPRS Release 99, is removed.

The GGSN 28 maintains for each APN a list of addresses used by all the MSs having an active PDP context connected to that APN. In practice, in GPRS the addresses can be found in the list of active PDP contexts maintained by the GGSN 28 since the IP address of the MS is stored in every PDP context. Therefore, the list of addresses currently in use is an integral part of the list of active PDP contexts.

Upon reception of the Neighbor Solicitation message in step 102, the GGSN 28 first checks, in step 104, if there is already an address allocated to the PDP context on which the message has been received. If an address already exists for the PDP context, the GGSN 28, in step 108, checks whether the tentative address received in the Neighbor solicitation is identical to the address stored in the PDP context. If the tentative address is identical to the address stored in the PDP context, the Neighbor Solicitation message is a repetition, and is silently discarded by the GGSN 28 in step 118 without any further processing. As a result, the MS 52 determines that continued use of the tentative address is allowed.

If the GGSN 28 determines in step 108 that the tentative address is different from the one stored in the PDP context and the address stored in the PDP context is not the link-local address, the MS is trying to acquire an additional site-local or global address, e.g. after changing its interface identifier due to the implementation of RFC 3041 in the MS. The GGSN can then determine in step 110 if the multiple IP addresses are allowed in connection with one PDP context. If, at step 110, the GGSN 28 determines that multiple IP addresses are not allowed, the process continues to step 116. At step 116, GGSN 28 rejects the tentative address by sending a Neighbor Advertisement message back to the MS 52 pretending that the tentative address is already in use. If, at step 110, the GGSN 28 determines that multiple IP addresses are allowed based upon locally defined policy, the process continues to the step 112. In step 112, the GGSN 28 determines if the tentative address is used by another PDP context. If, in step 112, the GGSN 28 determines that the tentative address in used by another PDP context, the process continues to the aforementioned step 116 in which the GGSN 28 sends a Neighbor Advertisement message to the MS 52. If, in step 112, the GGSN 28, determines that the tentative address in not being used by another PDP context, the process continues to step 114. At step 114, the GGSN 28 adds the tentative address to the list of addresses currently in use for the APN. After step 114, the process continues to the aforementioned step 118, in which the GGSN ignores the Neighbor Solicitation message.

If, at step 104, it is determined that there is no address stored in the PDP context, then, in step 106, the GGSN searches through the list of addresses currently in use on the APN in an attempt to locate the tentative address. If, in step 106, a matching address is found in the list, the address that the MS is trying to acquire is a duplicate and consequently the process continues to the aforementioned step 116, in which the GGSN 28 returns a Neighbor Advertisement message to the requesting MS 52 on behalf of the MS to which the address is already assigned (i.e., the GGSN 28 acts as a proxy for the MS to which the address is already assigned). In this case, the MS has to select or generate a different interface identifier and build a new address or, if this is not possible, report the error to the user. If the tentative address is not found in the list at step 106, the tentative address is unique and the process proceeds to the aforementioned step 114, in which the GGSN 28 adds the tentative address to the list of addresses currently in use for the APN. After step 114, the process proceeds to aforementioned step 118, in which the Neighbor Solicitation message is ignored. The GGSN 28 discards the Neighbor Solicitation message without replying with a Neighbor Advertisement message, thereby informing the requesting MS that the requested address has been allocated for use by the requesting MS.

As will be appreciated by those of ordinary skill in the art, if only stateless address autoconfiguration is used on an APN, such as with current procedures in which stateful address autoconfiguration is not supported concurrently on the same APN, the procedure can be optimized by basing the search by the GGSN for a matching address on the interface identifier only, i.e., the upper 64 bits of the address can be ignored in the comparison.

According to the specification of GPRS release 99, only one IP address is allowed per PDP context. As such, only the full IPv6 address is stored in the PDP context and not the link-local address. If the same procedure as described above was applied when an MS is performing duplicate address detection on its link-local address, no matching address would be found in other PDP contexts, even though the same interface identifier could be in use by another MS that has already configured its full IPv6 address. Therefore, in a system allowing only one IP address per PDP context, such as GPRS release 99, the search for a matching address should be based upon the interface identifier only. Otherwise, the procedure remains essentially the same, except that a change of interface identifier must inherently be rejected, as it would result in the MS using more than one full IPv6 address simultaneously.

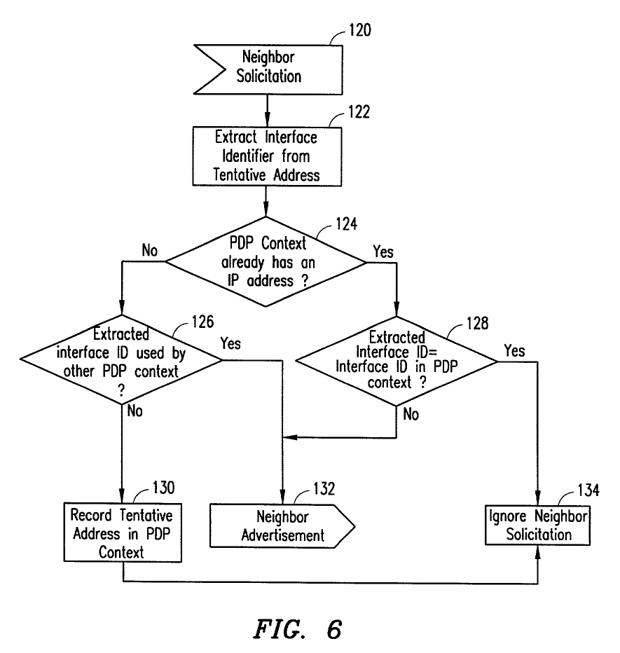

Referring now to FIG. 6, a flow diagram is shown illustrating the processing of a Neighbor Solicitation message in accordance with another embodiment of the present invention. In accordance with this embodiment of the present invention, only one IP address is allowed per PDP context. This procedure assumes that only stateless address autoconfiguration is allowed on a given APN, as required by the current GPRS release 99 standards.

Upon reception of a Neighbor Solicitation message from an MS in step 120, the GGSN 28, in step 122, extracts the interface identifier from the tentative address within the Neighbor Solicitation message. In step 124, the GGSN 28 then checks if there is already an address allocated to the PDP context on which the Neighbor Solicitation message has been received. If an address already exists for this PDP context, the GGSN 28, in step 128, checks whether the interface identifier extracted from the Neighbor solicitation is identical to the interface identifier stored in the PDP context. If the extracted interface identifier is identical to the interface identifier stored in the PDP context, the GGSN 28, in step 134, ignores the Neighbor Solicitation message. If the extracted interface identifier is different from the interface identifier stored in the PDP context, the GGSN 28, in step 132, returns a Neighbor Advertisement message to the MS on behalf of the MS to which the address has already been assigned.

If it is determined at step 124 that there is no IP address stored in the PDP context, then the GGSN 28 determines at step 126, if the extracted interface identifier is used by another PDP context. If the extracted interface identifier is in use by another PDP context, the GGSN 28 returns, in step 132, a Neighbor Advertisement message to the MS on behalf of the MS to which the address is already assigned. If the extracted interface identifier is not found to be in use by another PDP context, the interface identifier is unique and the GGSN 28, at step 130, records the tentative address in the PDP context. After step 130, the process proceeds to aforementioned step 134, in which the Neighbor Solicitation message is ignored. If the MS receives a Neighbor Advertisement message, the MS has to select or generate a different interface identifier and build a new address or, if this is not possible, report the error to the user.

In accordance with the present invention, standard IPv6 address configuration mechanisms, and in particular duplicate address detection procedures, are possible in the GPRS system while keeping to a minimum the usage of radio resources during the address autoconfiguration procedure. In particular, the present invention allows terminals to choose their own interface identifier, as intended by the IPv6 stateless address autoconfiguration procedure as defined in RFC 2462. Additionally, the present invention allows the GGSN to have a mechanism for restricting an MS to the use of a specific number of addresses, where that limit can be one by preventing the MS from changing its interface identifier or where the limit can be higher than one. The use of a proxy node in accordance with the present invention also permits the MS to regularly change its interface identifier in accordance with RFC 3041. Moreover, the invention can be implemented such that the change is transparent to the MS. Thus, the MS does not need to be modified.

It should be understood that the Proxy DAD function in accordance with the present invention is not limited to GPRS, and could be used in other systems as well where multicasting from one communication node to many communication nodes is undesirable or is not possible. The Proxy DAD function in accordance with the present invention is particularly suited for any system that supports IPv6 and is composed of a large number of point-to-point links all sharing the same network prefix or set of network prefixes, and where a bridging device, which consolidates all these links into a single network, ensures forwarding of packets to the appropriate destination link. The bridging device can implement the Proxy DAD function by keeping track of the addresses in use on each link and by performing Proxy Neighbor Solicitation/Neighbor Advertisement processing, thereby limiting multicast network traffic throughout the network. Examples of systems that can benefit from this invention are cable modem networks, IMT-2000 systems (also called 3G wireless systems) such as CDMA-2000, UMTS (UMTS uses GPRS as a packet switched bearer), etc.

The proxy DAD function in accordance with the present invention can also be used in network configurations in which a single prefix spans multiple physical networks via some bridging device or devices. These bridging device(s) can keep track of the addresses in use on each physical network and perform Proxy Neighbor Solicitation/Neighbor Advertisement processing to reduce multicast network traffic across physical networks. A bridged Ethernet network is an example of such a configuration.

As should be understood to those of ordinary skill in the art, the present invention may be implemented as a computer program stored on a computer-readable medium, loadable into the internal memory of a digital processing unit, the computer program including software code portions adapted to execute the step of receiving, by a proxy node, a solicitation message including a tentative interface address, the tentative interface address being associated with a particular one of a plurality of communication nodes. The software code portions may further be adapted to execute the step of determining, from the solicitation message, whether the tentative interface address is allocated to another of the plurality of communication nodes. In addition, the software instructions may be adapted to execute the step of sending a response message to the particular communication node if the proxy node determines that the tentative interface address is allocated to another of the plurality of communication nodes.

Although a preferred embodiment of the system, method, and apparatus, of the present invention has been illustrated in the accompanying Drawings and described in the foregoing Detailed Description, it is understood that the invention is not limited to the embodiment disclosed, but is capable of numerous rearrangements, modifications, and substitutions without departing from the invention as set forth and defined by the following claims.

What is claimed is:

1. A system for duplicate address detection in a communication network, said system comprising:
a plurality of communication nodes, a particular one of said communication nodes generating a tentative interface address and transmitting a solicitation message including the tentative interface address; and
a proxy node for receiving the solicitation message, said proxy node operable to determine from the solicitation message whether the tentative interface address is allocated to another of said plurality of communication nodes, and further operable to send a response message to said particular communication node if said proxy node determines that the tentative interface address is allocated to another of said plurality of communication nodes, said response message indicating that the tentative interface address is already in use.

2. The system of claim 1, wherein the particular communication mode transmits a context activation message to the proxy node at least as early as said transmission of the solicitation message, said context activation message indicative of a request for an activation of a packet data protocol context.

3. The system of claim 2, wherein the proxy node, responsive to the context activation message, generates a packet data protocol context associated with the particular communication node.

4. The system of claim 2, wherein the packet data protocol context is activated in accordance with IPv6.

5. The system of claim 1, wherein the particular communication node is allocated the tentative interface address as an allocated interface address if the proxy node determines that the tentative interface address is not allocated to another of said plurality of communication nodes.

6. The system of claim 5, wherein the particular communication node begins using the allocated interface address when no response is received to the solicitation message.

7. The system of claim 5, wherein the particular communication node begins using the allocated interface address when no response is received after repeating the solicitation message a predetermined number of times.

8. The system of claim 5, wherein the proxy node transmits a router advertisement message including network address prefix information.

9. The system of claim 8, wherein the transmission of the router advertisement message is performed automatically by the proxy node.

10. The system of claim 8, wherein the transmission of the router advertisement message is in response to the receiving, at the proxy node, of a router solicitation message transmitted by the particular communication node.

11. The system of claim 8, wherein the particular communication node receives the router advertisement message and determines a full network address associated with the particular communication node from the router advertisement message.

12. The system of claim 8, wherein the particular communication node receives the router advertisement message, extracts the network address prefix information from the router advertisement message, and concatenates the network prefix address prefix information and the tentative interface address to form a full network address associated with the particular communication node.

13. The system of claim 12, wherein the full network address comprises a site-local address.

14. The system of claim 12, wherein the full network address comprises a global address.

15. The system of claim 8, wherein the proxy node stores at least a characteristic portion of a full network address in a packet data protocol context associated with the particular communication node.

16. The system of claim 1, wherein the tentative interface address comprises a link-local address.

17. The system of claim 1, wherein the particular communication node subsequently generates a new tentative interface address and transmits a new solicitation message including the new tentative interface address.

18. The system of claim 17, wherein the proxy node receives the new solicitation message, determines whether the new tentative interface address is allocated to another of said plurality of communication nodes, generates a new response message to the particular node if the proxy node determines that the new tentative interface address is allocated to another of said plurality of communication nodes, and allocates the new tentative interface address as a new allocated interface address if the proxy node determines that the new tentative interface address is not allocated to another of said plurality of communication nodes.

19. The system of claim 17, wherein the proxy node receives the new solicitation message, and transmits a new response message to the particular node if the allocation of an additional interface address associated with the particular node is not allowed.

20. The system of claim 17, wherein the generation of the new tentative interface address is performed in accordance with a stateless IPv6 address autoconfiguration procedure.

21. The system of claim 1, wherein the particular communication node comprises a mobile station.

22. The system of claim 1, wherein the particular communication node comprises terminal equipment.

23. The system of claim 1, wherein the proxy node comprises a gateway node.

24. The system of claim 23, wherein the gateway node comprises a gateway general packet radio service support node (GGSN).

25. The system of claim 1, wherein the proxy node comprises a network bridging device for interfacing the plurality of communication nodes to at least one packet data network.

26. The system of claim 1, wherein the communication network comprises at least one of a cable modem network, an IMT-2000 network, a CDMA-2000 network, a UMTS network, and a General Packet Radio Service (GPRS) network.

27. A method for duplicate address detection in a communication network, said method comprising:
generating, by a first one of a plurality of communication nodes, a first tentative interface address;
transmitting, from the first communication node, a first solicitation message including the first tentative interface address;
receiving, at a proxy node, the first solicitation message;
determining, by the proxy node, that the first tentative interface address is available for use by the first communication node;
allocating the first tentative interface address as a first allocated interface address associated with the first communication node;
generating, by a second one of the plurality of communication nodes, a second tentative interface address;
transmitting, from the second communication node, a second solicitation message including the second tentative interface address;
receiving, at the proxy node, the second solicitation message;
determining, by the proxy node, whether the second tentative interface address corresponds to the first allocated interface address;
generating a first response message if the proxy node determines that the second tentative interface address corresponds to the first allocated interface address; and
transmitting the first response message to the second communication node.

28. The method of claim 27, further comprising the steps of:
generating, by the first communication node prior to the step of generating the first tentative interface address, a context activation message, the context activation message indicative of a request for the activation of a packet data protocol context;
transmitting the context activation message from the first communication node to the proxy node; and
generating, at the proxy node, a packet data protocol context associated with the first communication node.

29. The method of claim 27, further comprising the steps of:
generating, at the proxy node, a router advertisement message, the router advertisement message including network address prefix information;
transmitting, from the proxy node, the router advertisement message;
receiving, at the first communication node, the router advertisement message; and
determining, using the router advertisement message, a full network address associated with the first communication node.

30. The method of claim 29, wherein the step of determining the full network address comprises:
extracting the network address prefix information from the router advertisement message; and
concatenating, by the first communication node, the network address prefix and the first allocated interface address to form the full network address associated with the first communication node.

31. The method of claim 29, wherein the step of generating the router advertisement message is in response to the receiving, at the proxy node, of a router solicitation message generated by and transmitted from the first communication node.

32. The method of claim 29, wherein the first tentative interface address comprises a tentative interface identifier.

33. The method of claim 30, wherein the full network address comprises a site-local address.

34. The method of claim 30, wherein the full network address comprises a global address.

35. The method of claim 29, wherein the communication network comprises a General Packet Radio Service (GPRS) network and the proxy node comprises a gateway support node, said method further comprising the steps of:
storing, by the gateway support node, at least a characteristic portion of a full network address in a packet data protocol context associated with the first communication node;
generating, by the gateway support node, a context modification message indicative of the storing of the at least a characteristic portion of the full network address; and
transmitting, from the gateway support node to a serving support node, the context modification message.

36. The method of claim 27, further comprises the steps of:
generating, by the first communication node, a third tentative interface address;
transmitting, from the first communication node, a third solicitation message including the third tentative interface address;
receiving, at the proxy node, the third solicitation message; and
determining, by the proxy node, if the third tentative interface address is allocated to one of the plurality of communication nodes.

37. The method of claim 36, further comprising the step of:
allocating the third tentative interface address as a second allocated interface address associated with the first communication node if the third tentative interface address is not allocated to one of the plurality of communication nodes.

38. The method of claim 36, further comprising the steps of:
generating a second response message if the proxy node determines that the third tentative interface address is allocated to one of the plurality of communication nodes;
transmitting the second response message to the first communication node;
receiving, at the first communication node, the second response message; and
transmitting, from the first communication node, a third solicitation message including a fourth tentative interface address in response to the second response message.

39. The method of claim 38, further comprising the step of allocating the third tentative interface address as a third allocated interface address if the proxy node determines that the fourth tentative interface address is not allocated to one of the plurality of communication nodes.

40. The method of claim 36, further comprising the steps of:
generating a second response message if the allocation of an additional interface address associated with the first communication node is not allowed; and
transmitting the second response message to the first communication node.

41. A proxy node for duplicate address detection in a communication network, said proxy node comprising:
an input interface for receiving a solicitation message including a tentative interface address, the tentative interface address being associated with a particular one of a plurality of communication nodes;
a processor operable to determine from the received solicitation message, and using obtained information relating to interface addresses that are currently allocated to the plurality of communication nodes, whether the tentative interface address is allocated to another of the plurality of communication nodes, and generate a response message if the processor determines that the tentative interface address is allocated to another of said plurality of communication nodes; and
an output interface in communication with said processor, for transmitting said response message to the particular communication node.

42. The proxy node of claim 41, the proxy node further comprising means for storing the information relating to interface addresses that are currently allocated to the plurality of communication nodes in a memory associated with the proxy node.

43. The proxy node of claim 41, the proxy node further comprising means for retrieving the information relating to interface addresses that are currently allocated to the plurality of communication nodes from a support node.

44. The proxy node of claim 43, wherein the support node comprises a gateway general packet radio service support node (GGSN).

45. The proxy node of claim 41, wherein the processor is further operable to receive a context activation message indicative of a request from the particular communication node for the activation of a packet data protocol context, and generate a packet data protocol context associated with the particular communication node.

46. The proxy node of claim 41, wherein the processor is further operable to transmit a router advertisement message, the router advertisement message including network address prefix information.

47. The proxy node of claim 46, wherein the transmitting of the router advertisement message is in response to a reception of a router solicitation message transmitted from the particular communication node.

48. The proxy node of claim 41, wherein the processor is further operable to store at least a characteristic portion of a full network address in a packet data protocol context associated with the particular communication node.

49. The proxy node of claim 48, wherein the processor is further operable to transmit a context modification message indicative of the storing of the at least a characteristic portion of the full network address.

50. The proxy node of claim 41, wherein the particular communication node comprises a mobile station.

51. The proxy node of claim 41, wherein the proxy node comprises a gateway node.

52. The proxy node of claim 51, wherein the gateway node comprises a gateway general packet radio service support node (GGSN).

53. The proxy node of claim 41, wherein the proxy node comprises a network bridging device interfacing the plurality of communication nodes to at least one packet data network.

54. The proxy node of claim 41, wherein the communication network comprises at least one of a cable modem network, an IMT-2000 network, a CDMA-2000 network, a UMTS network, and a General Packet Radio Service (GPRS) network

55. A method for duplicate address detection in a communication network, said method comprising:
receiving, by a proxy node, a solicitation message including a tentative interface address, the tentative interface address being associated with a particular one of a plurality of communication nodes;
determining, from the solicitation message, whether the tentative interface address is allocated to another of said plurality of communication nodes; and
sending a response message to said particular communication node if, in said determining step, the proxy node determines that the tentative interface address is allocated to another of said plurality of communication nodes.

56. The method of claim 55, further comprising the steps of:
receiving, from the particular communication node, a context activation message indicative of a request from the particular communication node for the activation of a packet data protocol context; and
generating a packet data protocol context associated with the particular communication node.

57. The method of claim 55, further comprising the steps of:
generating a router advertisement message, the router advertisement message including network prefix information; and
transmitting the router advertisement message.

58. The method of claim 57, wherein the step of generating the router advertisement message is in response to a reception of a router solicitation message from the particular communication node.

59. The method of claim 55, further comprising the step of:
storing at least a characteristic portion of a full network address in a packet data protocol context associated with the particular communication node.

60. The method of claim 59, further comprising the step of:
transmitting a context modification message indicative of the storing of the at least a characteristic portion of the full network address.

61. A computer readable medium, the computer readable medium storing software instructions, the software instructions operable, when executed by a processor, to:
receive, by a proxy node, a solicitation message including a tentative interface address, the tentative interface address being associated with a particular one of a plurality of communication nodes;
determine, from the solicitation message, whether the tentative interface address is allocated to another of said plurality of communication nodes; and
send a response message to said particular communication node if the proxy node determines that the tentative interface address is allocated to another of said plurality of communication nodes.

62. The computer readable medium of claim 61, the software instructions further operable, when executed by a processor, to:
receive, from the particular communication node, a context activation message indicative of a request from the particular communication node for the activation of a packet data protocol context; and
generate a packet data protocol context associated with the particular communication node.

63. The computer readable medium of claim 61, the software instructions further operable, when executed by a processor, to:
generate a router advertisement message, the router advertisement message including network prefix information; and
transmit the router advertisement message.

64. The computer readable medium of claim 63, wherein the generating the router advertisement message is in response to a reception of a router solicitation message from the particular communication node.

65. The computer readable medium of claim 61, the software instructions further operable, when executed by a processor, to:
store at least a characteristic portion of a full network address in a packet data protocol context associated with the particular communication node.

66. The computer readable medium of claim 65, the software instructions further operable, when executed by a processor, to:
transmit a context modification message indicative of the storing of the at least a characteristic portion of the full network address.

67. The computer readable medium of claim 66, the software instructions further operable, when executed by a processor, to:
transmit a context modification message indicative of the storing of the at least a characteristic portion of the full network address.
